(19) United States
(12) Patent Application Publication
(10) Pub. No.: US 2004/0174053 A1
(43) Pub. Date: Sep. 9, 2004

(54) Safety device that prevents accident-related injuries of a user of a vehicle seat and mechanical system for detecting a vehicle impact

(76) Inventor: Uwe Schmale, Hueckeswagen (DE)

Correspondence Address: FOLEY & LARDNER, 777 EAST WISCONSIN AVENUE, SUITE 3800, MILWAUKEE, WI, 53202-5308, US

(21) Appl. No.: 10/477,342

(22) PCT Filed: May 4, 2002
(86) PCT No.: PCT/EP02/04930

(30) Foreign Application Priority Data
May 8, 2001 (DE) 201 07 765.5

(51) Int. Cl. B60N 2/42

(52) U.S. Cl. 297/216.12

(57) ABSTRACT

A protection device that prevents accident-related injuries of a user of a vehicle seat, having a device which, in the event of a vehicle impact, in particular a rear impact, moves a component of the vehicle seat, in particular an upper backrest part of a backrest, from a normal operational position into a safety position, in particular pivots it through an angular region relative to a lower backrest part about an axis running transversely with respect to the longitudinal axis of the vehicle in a backrest of the vehicle seat under the effect of a torque, having locking means for fixing the component in the normal operational position, and having means for detecting the vehicle impact, which means are formed by a mechanical system which has parts which—accelerated by the effects of the vehicle impact—cancel the fixing of the component by bringing the locking means into an unblocked position.

### CROSS-REFERENCE TO RELATED PATENT APPLICATIONS

This application is the National Stage of International Application No. PCT/EP02/04930, filed May 4, 2002 and German Utility Model Application No. DE20107765.5, filed May 8, 2001.

### BACKGROUND OF THE INVENTION

The present invention relates to a protection device that prevents accident-related injuries of a user of a vehicle seat, having a device which, in the event of a vehicle impact, in particular a rear impact, moves a component of the vehicle seat, in particular an upper backrest part of a backrest, from a normal operational position into a safety position, in particular pivots it through an angular region relative to a lower backrest part about an axis running transversely with respect to the longitudinal axis of the vehicle in a backrest of the vehicle seat under the effect of a torque, having locking means for fixing the component in the normal operational position, and having means for detecting the vehicle impact, which means are formed by a mechanical system which has parts which—accelerated by the effects of the vehicle impact—cancel the fixing of the component by bringing the locking means into an unblocked position.

Furthermore, the invention relates to a mechanical system for detecting a vehicle impact, which has parts responding to acceleration.

### SUMMARY OF THE INVENTION

A protection device and a system of this type are disclosed in WO 01/12465 A1. This document describes a backrest for a vehicle seat having an integrated protection device that prevents accident-related injuries in the event of a rear impact, in particular against cervical vertebra syndrome or whiplash trauma, having a backrest part which is connected to a seat part and having an upper backrest part which can be pivoted relative to the lower backrest part about an axis running transversely with respect to the longitudinal axis of the vehicle in the backrest, from a normal operational position in a pivoting direction, which points in the direction of travel, and through an angled region by means of a torque which acts in the pivoting direction. In comparison with similar known protection devices, the protection device described ensures improved protection against injury, in particular an improved possibility of interception and damping when the head and the upper body of the person on the seat strike against a head restraint and the backrest, respectively, wherein, in the normal operational position, a locking which is effective but does not obstruct the release process is realized. For this purpose, the protection device has at least the following parts.

A device which produces the torque which acts in the pivoting direction on the upper backrest part irrespective of whether the vehicle seat is occupied,

Means for detecting a rear impact, which means are in operative connection with the torque-producing device in such a manner that, in the event of the rear impact, the device is activated and the pivoting movement is initiated, and

Locking means for fixing the upper backrest part in the normal operational position, the locking means being formed from a lever system and the means for detecting a rear impact being in operative connection with the locking means for fixing the upper backrest part in the normal operational position in such a manner that, in the event of the impact, the fixing of the upper backrest part in the normal operational position is cancelled.

WO 01/12465 A1 furthermore describes in detail that an actuation of the locking means can preferably be undertaken by a solenoid which obtains its pulse from a sensor, such as from an acceleration sensor, which is used as a means for detecting the rear impact. Sensors of this type operate, for example, on the basis of the piezoelectric effect and thus, for installation, require at least one electrical installation. Furthermore, WO 01/12465 A1 expresses the basic concept that the means for detecting the rear impact could also be formed by a mechanical control system which has mechanical parts which—accelerated by the effect of the rear impact—bring the locking means into an unlocked position. However, no further measures are mentioned in regard of the specific technical conversion of this basic concept. In actual fact, the requirement for the locking means to function precisely in respect of their release time could, up to now, only be med by a pyrotechnic release device which was activated by means of the sensor mentioned. However, a release device of this type means a considerable outlay on components and installation time, which may result in cost problems particularly in the case of mass-produced vehicles.

The present invention is based on the object of providing, with structurally uncomplicated means, a protection device and a mechanical impact detection system of the type mentioned at the beginning, with which the requirement for the locking means to precisely function with respect to the their release time can be met effectively. As far as the mechanical system is concerned, this should be able to be used, if the need arises, with great precision as an alternative to a vehicle crash sensor irrespective of its integration in the protection device.

The object on which the invention is based is achieved, firstly, by a protection device of the type mentioned at the beginning, in which the mechanical system is formed from a pendulum-type lever which is connected mechanically to the locking means and to the free end of which mass element is fastened.

According to the invention, this makes it possible, using surprisingly simple means, to ensure that the blocking position of the locking means of the protection device is cancelled rapidly and in a highly precise manner with respect to the release time, and the substitution of an acceleration sensor, which is more complicated to provide and install, as the means for detecting a vehicle impact is possible. In particular, in the case of a rear impact on the vehicle, the upper backrest part (as the component to be brought into a safety position) is brought into the safety position in the course of a few milliseconds before the rear impact causes the seat user's head to start moving.

In this case, a protection device, in which the locking means are formed from a lever system comprising at least two interacting levers, is particularly preferred. A lever system of this type can be formed, for example, from a catch which is mounted pivotably in the upper backrest part and is supported, in a blocking position, on a counterbearing fixed relative to the upper backrest part, and from a pivotably mounted locking lever which engages in the catch in a blocking position and releases the catch in a release position. In this case, the pendulum-type lever can be connected in a rotationally fixed manner to the pivotably mounted locking lever, the pendulum axis of the pendulum-type lever being aligned, in particular, coaxially with the pivoting axis of the pivotably mounted locking lever. Since a construction of this type does not require an electrical installation, it is particularly easy to install. The release of the locking lever can be realized with only a very small actuating force, which makes a very rapid lever movement and therefore rapid unlocking of the catch possible.

In respect of the efficiency of the protection device, it is particularly advantageous if a head restraint is fastened in or on the upper backrest part (as the component to be brought into a safety position). The effect therefore achieved for the head restraint is that, if the upper backrest part is in the normal operational position, said head restraint is in a “comfort position”, in which its distance from the head of a seat user can be approximately 40 to 110 mm. By means of the pivoting movement of the upper backrest part, the head restraint is then transferred into an “intercepting position”, in which its distance from the head of a seat user is zero or virtually zero. When a head restraint is present, the normal operational position and the safety position of the upper backrest part therefore correspond to the comfort position and the intercepting position of said head restraint.

The device, which, in the event of a vehicle impact, moves the component of the vehicle seat, in particular the upper backrest part of the backrest, in particular pivots it through an angular region relative to a lower backrest part about an axis running transversely with respect to the longitudinal axis of the vehicle in a backrest of the vehicle seat under the effect of a torque, can advantageously be designed as a device, in a particularly preferred embodiment as a prestresed torsion spring which is arranged in the pivoting axis and produces the torque irrespective of whether the vehicle seat is occupied, as is known per se from WO 01/12465 A1.

In order to detect a vehicle impact effectively, the size of a mass of the mass element and length of the pendulum can, in particular, be coordinated with each other in such a manner that, when accelerations in the region of approximately 3 g to 20 g, in particular in the region of approximately 40 to 80 m/s² in a “low speed crash” (driving speed 10-30 km/h) occur, the pendulum-type lever is deflected by a defined amount.

Further advantageous refinement features of the invention are contained in the subclaims and in the following description.

### BRIEF DESCRIPTION OF THE DRAWINGS

The invention will be explained in greater detail and by way of example with reference to the drawing, in which:

FIG. 1 shows a perspective, partially schematized side view of a backrest with a protection device according to the invention,

FIG. 2 shows a side view of a preferred embodiment of a backrest with a protection device according to the invention and including the illustration of a seat user,

FIG. 3 shows a perspective illustration of the upper part of the backrest illustrated in FIG. 2,

FIG. 4 shows a lateral sectional view through the upper part (illustrated in FIG. 3) of the backrest in a central region (plane IV-IV-IV-IV), with a detailed illustration of a preferred embodiment of the mechanical system designed in accordance with the invention for detecting a vehicle impact.

### DETAILED DESCRIPTION OF THE PREFERRED EMBODIMENTS

In the various figures of the drawing, identical parts are always provided with the same reference numbers, and so they are generally also only described one in each case.

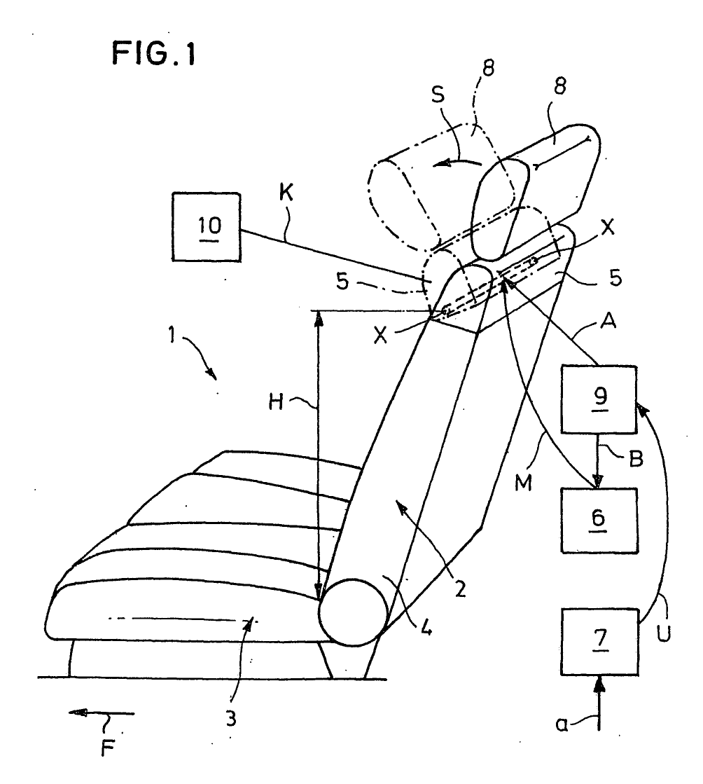

As emerges first of all from FIG. 1, a vehicle seat 1 comprises a backrest 2 in which a protection device according to the invention is integrated, and a seat part 3. In the embodiment illustrated, the protection device according to the invention serves to protect a person using the vehicle seat 1 against accident-related injuries, in particular against cervical vertebra syndrome or whiplash trauma, in the event of a rear impact. The backrest 2 has a lower backrest part 4 which is connected to the seat part 3 and an upper backrest part 5 which can be pivoted relative to the lower backrest part 4 about an axis X-X running transversely with respect to the longitudinal axis of the vehicle in the backrest 2, from a normal operational position (shown by a solid line in FIG. 1) in a pivoting direction S, which points in the direction of travel F, and through an angled region into a safety position (shown by a chain-dotted line in FIG. 1) by means of a torque which acts in the pivoting direction S.

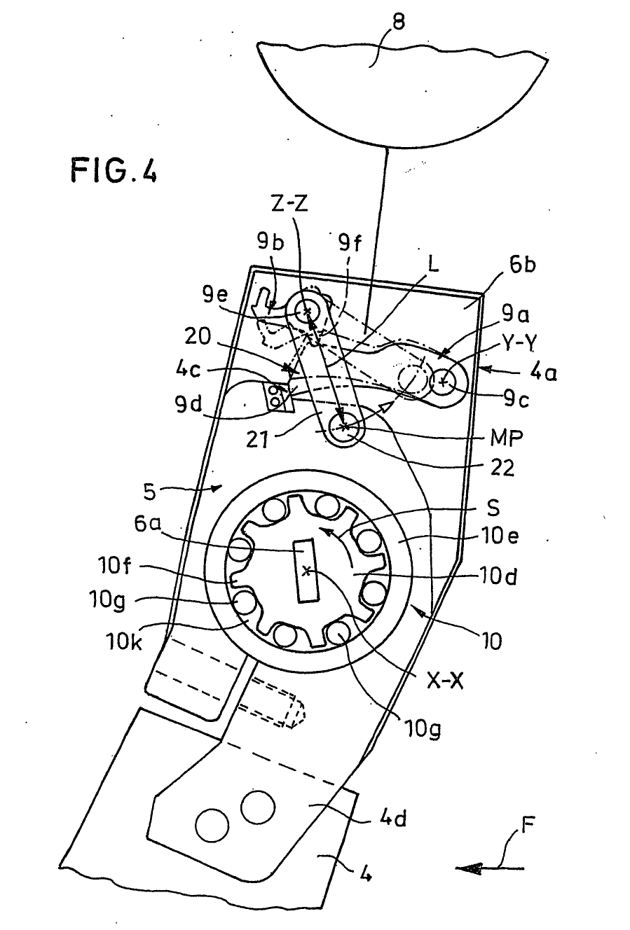

The protection device has, firstly, a device 6 which, irrespective of whether the vehicle seat 2 is occupied, produces the torque (arrow M in FIG. 1) which: acts in the pivoting direction S on the upper backrest part 5 and, secondly, has means 7 for detecting a rear impact. The torque-producing device 6 may be designed differently and the means 7 for detecting a rear impact are designed as a mechanical system according to the invention, as is explained in detail below with reference to FIG. 4. These parts of the backrest 2 (torque-producing device 6, means 7 for detecting the rear impact) are shown first of all in FIG. 1 only in a schematized manner (as small boxes).

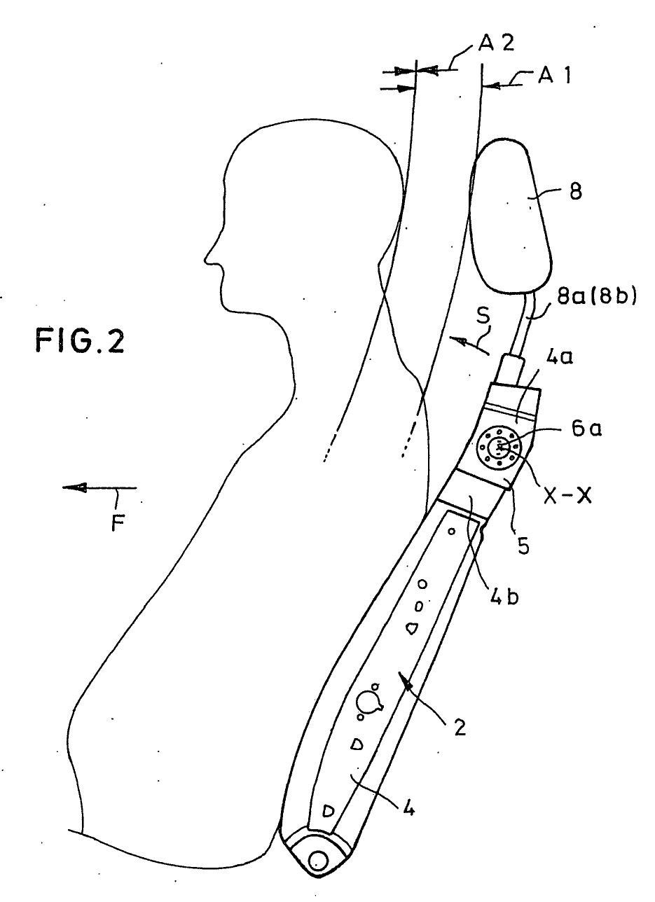

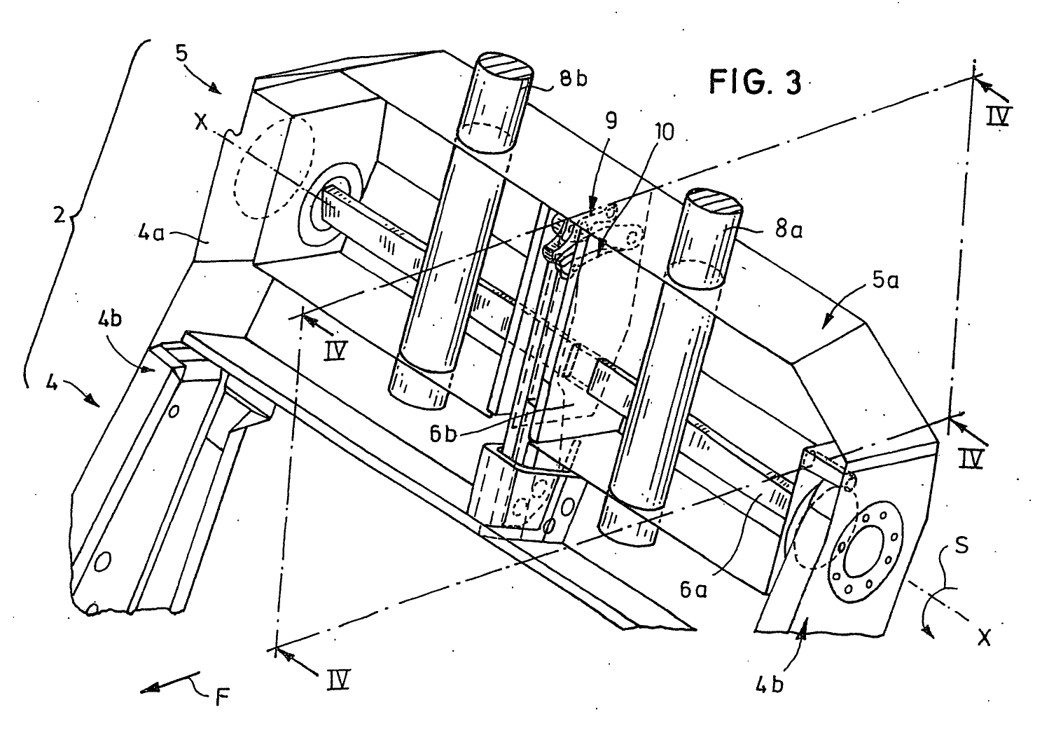

The torque-producing device 6 can advantageously be formed, for example, by a force or energy accumulator, in particular by a prestressed spring element or a plurality of prestressed spring elements. In the illustrated embodiment of the invention, which is shown in FIGS. 2 to 4, the torque-producing device 6 is designed as a leaf-shaped torsion spring (torsion spring 6a) which lies in the pivoting axis X-X, which runs transversely with respect to the longitudinal direction of the vehicle, of the upper backrest part 5, advantageously has a very small neutral acceleration and, while having the same effect, only requires a small amount of structural space in comparison to tension or compression springs (cf. FIG. 3, in particular).

The detecting means 7 are in operative connection with the torque producing device 6 in such a manner that, in the event of the rear impact, the device 6 is activated and the pivoting movement of the upper backrest part 5 is initiated. In this case, the lower backrest part 4 remains in its original (normal operational) position.

In order to ensure optimum protection of the seat user, the lower backrest part 4 and the upper backrest part 5 can preferably be coordinated with each other in their respective lengths (not referred to specifically) in a defined manner and the axis X-X which runs transversely with respect to the longitudinal axis of the vehicle and about which the upper backrest part 5 can be pivoted can be arranged at a defined height H in the shoulder region of a seat user, preferably approximately 400 to 500 mm above the seat part 3.

A head restraint 8 is fastened in or on the upper backrest part 5 and, in the case of a rear impact, is moved from a comfort position (shown by a solid line in FIG. 1), in which its distance (A1 in FIG. 2) from the head of a seat user is approximately 80 to 120 mm, into an intercepting position (shown by a chain-dotted line in FIG. 1), in which its distance (A2 in FIG. 2) from the head of a seat user is zero or virtually zero.

Furthermore, locking means 9 for fixing the upper backrest part 5 in the normal operational position are provided. This fixing is illustrated by the arrow A in FIG. 1. These locking means 9 are formed by a lever system, as will be described in greater detail below with reference to FIGS. 3 and 4. It is indicated by means of the arrow B in FIG. 1 that the locking means 9 block the effect of the torque-producing device 6.

The means 7 for detecting a rear impact are in operative connection (arrow U in FIG. 1) with the locking means 9 for fixing the upper backrest part 5 in the normal operational position in such a manner that, in the event of the impact, the fixing A of the upper backrest part 5 in the normal operational position and the blocking B of the torque-producing device 6 are cancelled.

Further locking means 10, the action of which is illustrated by the arrow K in FIG. 1 and which will be explained by way of example below with reference to FIG. 4, can advantageously be provided to fix the upper backrest part 5 against moving back from the safety position into the normal operational position.

In the described embodiment of the invention, the novel protection device which is not referred to specifically as a whole and which is integrated in the backrest 2 of the vehicle seat 1 is therefore formed by the lower backrest part 4, the upper backrest part 5 which can be pivoted about the axis X-X and has the head restraint 8, the torque-producing device 6, the means 7 designed according to the invention for detecting a rear impact, the locking means 9 which are designed as a lever system and are intended for fixing the upper backrest part 5 in the normal operational position, and the locking means 10 for fixing the upper backrest part 5 against moving back from the safety position into the normal operational position.

FIG. 3, which shows an enlarged detail of the backrest 2 (illustrated in FIG. 2) in the region of the transition from the lower backrest part 4 to the upper backrest part 5, illustrates one preferred, specific embodiment for the device 6 which, irrespective of whether the vehicle seat 2 is occupied, produces the torque M which acts in the pivoting direction S on the upper backrest part 5, and, firstly, in the form of an overview, for the locking means 9 which are designed as a lever system and are intended for fixing the upper backrest part 5 in the normal operational position.

As has already been mentioned, the torque-producing device 6 according to FIG. 3 is designed as a prestressed spring element—to be precise, as a leaf-shaped torsion spring 6a which is mounted in the upper backrest part 5. A torsion spring 6a of this type advantageously enables very high actuating forces or a very high torque M to be produced madding it possible for the upper backrest part 5 to pivot within milliseconds. It has been proven advantageous for the spring element if it has a falling characteristic line which, in order to produce a pronounced acceleration, has a high initial force, but only a very low end force. This takes account, in particular, of the fact that owing to its arrangement in the vehicle, the upper backrest part 5 experiences, due to the crash, an acceleration which is opposed to the action of the spring element. It is in particular extremely advantageous if the torque-producing device 6 is designed in such a manner that, in the event of its activation, the upper backrest part 5 is accelerated in the pivoting direction S by a greater amount than a measured or, preferably, an empirically determined, average amount of the acceleration a which the vehicle eat 2 experiences because of the rear impact, this being able to be set by the spring characteristic (thickness and material of the torsion spring 6a).

FIG. 3 reveals—as known per se—retaining rods 8a, 8b of the head restraint 8 which are provided for setting the height position and by means of which the head restraint 8 is mounted in the backrest 2 level with the shoulder region of the seat user in a manner such that it can be tilted about an axis X-X running transversely with respect to the vehicle axis (for the height position of the axis X-X see H in FIG. 1). For this purpose, an upper transverse strut 5a of the backrest 2, which strut supports the restraining rods 8a, 8b, is mounted pivotably (pivoting direction S) about the axis X-X, in which the torsion spring 6a lies, in respective upper fastening sections 4a, which protrude over the lower backrest part 4, on two side struts 4b which are connected fixedly to the lower backrest part 4 the torsion spring 6a itself is clamped laterally at its ends in the fastening sections 4aand is connected fixedly to the transverse strut 5a approximately centrally via a retaining part 6b. It can therefore be prestressed in the normal operational position by rotating it counter to the pivoting direction S which is indicated.

A lever system which is supported by two side walls (not referred to specifically) of the retaining part 6b, which, in particular, is of pocket-like design, and which acts as an interlocking or frictional latch, is provided as locking means 9 for fixing the upper backrest part 5 in the normal operational position.

As FIG. 4 shows in greater detail in this respect, in the embodiments illustrated, the lever system comprises two interacting levers 9a, 9b which are mounted pivotably in the retaining part 6b. A first lever, in particular of single-armed design (catch 9a) is mounted laterally in bearings 9c of the retaining part 6b, the bearing axis Y-Y running parallel to the axis of rotation X-X of the upper backrest part 5, and supports the pivotable transverse strut 5a, which is prestressed by the torsion spring 6a, with respect to a fixed counterbearing 4c. The counterbearing 4c is situated here at the upper end of a supporting part 4d, which is connected at the other end fixedly to the lower backrest part 4 and protrudes into the pocket-like retaining part 6b, and is formed by a stop surface for a lug 9d of the catch 9a, which lug is arranged, for example, at the free lever end. In a blocking position of the catch 9a, the lug 9d bears against the counterbearing 4c.

The second lever (locking lever 9b) serves for locking the catch 9a in its blocking position. It is mounted laterally in bearings 93 of the retaining part 6b, the bearing axis Z-Z again running parallel to the axis of rotation X-X of the upper backrest part 5, and engages in its blocking position with a blocking lug 9f in an interlocking manner in the catch 9a in such a manner that said catch cannot move out of its blocking position. The illustration of FIG. 4 shows the blocking positions of the catch 9a and locking lever 9b in a fat solid line in each case and the unblocked position in a thin solid line.

When the need arises (rear impact), the locking lever 9b is pivoted counterclockwise about its bearing axis Z-Z—according to the illustration in FIG. 4, in which case the interlocking engagement of the blocking lug 9f in the catch 9a is cancelled and the catch 9a is released for a pivoting movement about its axis Y-Y (likewise counterclockwise according to the illustration in FIG. 4). In this case, the locking lever 9b can be released with just a very small actuating force.

After the catch 9a is released by the locking lever 9b, it is pivoted (counterclockwise according to the illustration selected) about its bearing axis Y-Y from its blocking position into its release position solely under the effect of the torsion spring 6a. In the process, the friction between the fixed stop surface of the counterbearing 4c and the supporting surface on the lug 9f of the catch 9a is overcome. The transverse strut 4a pivots with the head restraint 8 in the direction of the back of the vehicle occupant's head (intercepting position of the head restraint 8). The positions assumed in the process by the upper backrest part 5 and the head restraint 8 are—as already mentioned—shown by chain-dotted lines in FIG. 1.

The means 7 for detecting the rear impact are formed by a mechanical system 20 which is designed according to the invention and has mechanical parts which—accelerated by the action of the rear impact—disengage the locking lever 9b, i.e. bring it into an unlocked position. This corresponds to a direct operative connection U (FIG. 1) of the means 7 for detecting the rear impact with the locking means 9.

The system 20 is formed from a rigid pendulum-type lever 21 which is connected mechanically to the locking means 9 and to the free end of which a mass element 22 is fastened. In particular, the pendulum-type lever 21 is connected in a rotationally fixed manner to the pivotably mounted locking lever 9b. The pendulum axis of the pendulum-type lever 21 is aligned here coaxially with the pivoting axis Z-Z of the pivotably mounted locking lever 9b. The mass element 22 at the free end of the pendulum-like lever 21 is arranged below the pivoting axis Z-Z of the pivotably mounted locking lever 9b.

In the case of a rear impact, the free end of the pendulum-type lever 21 with the mass element 22 is pivoted counter to the direction of travel about the pendulum axis Z-Z under the effect of the acceleration forces which occur, as a result of which the locking lever 9b, which is connected in a rotationally fixed manner to the pendulum-type lever, is likewise pivoted—in the above-described manner—about the axis Z-Z, the interlocking engagement of the blocking lug 9f in the catch 9a is cancelled and the catch 9a is released for a pivoting movement, so that it can be pivoted from its blocking position into its release position under the effect of the torsion spring 6a.

Like the lever system forming the locking means 9 for fixing the upper backrest part 5 in the normal operational position, the pendulum-type lever 21 can be retained in the region of its pendulum axis Z-Z in the two side walls (not referred to specifically) of the retaining part 6b, which, in particular, is of pocket-like design.

For an efficient manner of operating the system 20, it is advantageous if the mass element 22 has a mass in the region of approximately 50 g to 300 g. In particular, the size of the mass of the mass element 22 at the free end of the pendulum lever 21 and a characteristic length L of the pendulum-type lever 21 between its pendulum axis Z-Z and a mass center of gravity MCG at the free end for detecting a vehicle impact should be coordinated with each other in such a manner that, when accelerations a in the region of approximately 3 g to 20 g, in particular in the region of approximately 40 to 80 m/s², occur, the locking means 9 are brought by the pendulum-type lever 21 into an unblocked position. This takes place when the pendulum-type lever 21 is deflected by a predetermined amount. If these values are dimensioned precisely, the type of construction of the vehicle and of the vehicle seat 1 are also significant.

As the locking means 10 for fixing the upper backrest part 5 against a movement back of the upper backrest part 5 from the safety position into the normal operational position and of the head restraint 8 from the intercepting position into the comfort position, various embodiments are possible, one of which is illustrated in FIG. 4. This embodiment shows a design of the locking means 10 for fixing the upper backrest part 5, in particular the transverse strut 4a, as a rolling-body blocking device. The rolling-body blocking device comprises a toothed ring 10d which is arranged concentrically about the pivoting axis X-X of the upper backrest part 5 and is arranged within a cylindrical casing 10e, and rolling bodies 10g which are arranged between the teeth 10 of the toothed ring 10d and between the toothed ring 10d and casing 10e. The torsion spring 6a is connected fixedly to the toothed ring 10d. the tooth flanks of the teeth 10f of the toothed ring 10d are designed in such a manner that the rolling-body blocking device permits the pivoting (pivoting direction S) into the safety position of the upper backrest part 5 and into the intercepting position of the head restraint 8, since the rolling bodies 10g can roll freely between the toothed ring 10d and casing 10e while, in the event of an opposing movement, the rolling bodies 10g become jammed between the toothed ring 10d and casing 10e, which prevents this movement back.

As already revealed from the above description, the invention is not restricted to the exemplary embodiment illustrated but rather also comprises all of the embodiments acting identically within the meaning of the invention. Thus, the mechanical system according to the invention for detecting a vehicle impact, in which a part responding to acceleration is formed from a pendulum, in particular from a pendulum-type lever, to the free end of which a mass element is fastened, could also, if the need arises, be used for detecting a frontal impact. It is therefore understood that the “acceleration” a may also concern negative values, i.e. a “deceleration”. the abovedescribed further lever which is connected to the pendulum-type lever does not have to be a locking lever, but could also be a different type of release lever.

The lever system could also, for example, be designed in a different manner than illustrated and than described and could be arranged at a different location. In respect of further possible details, reference is made in full to WO 01/12465 A1 which is mentioned at the beginning.

Furthermore, the invention is also not yet confined to the combination of features defined in claim 1 but can also be defined by any other desired combination of particular features of all disclosed individual features. This means that, in principle, virtually any individual feature of claim 1 can be omitted or replaced by at least one individual feature disclosed elsewhere in the application. To this extend, claim 1 is to be understood merely as a first attempt at formulating the invention.

What is claimed is:

1. A protection device that prevents accident-related injuries of a user of a vehicle seat (1),
having a device (6) which, in the event of a vehicle impact, in particular a rear impact, moves a component of the vehicle seat (1), in particular an upper backrest part (5) of a backrest (2), from a normal operational position into a safety position, in particular pivots it through an angular region relative to a lower backrest part (4) about an axis (X-X) running transversely with respect to the longitudinal axis of the vehicle in a backrest (2) of the vehicle seat (1) under the effect of a torque (M),
having locking means (9) for fixing (A) the component in the normal operational position, and having means (7) for detecting the vehicle impact, which means are formed by a mechanical system (20) which has parts which—accelerated by the effect of the vehicle impact—cancel the fixing (A) of the component by bringing the locking means (9) into an unblocked position,
characterized in that the mechanical system (20) is formed from a pendulum-type lever (21) which is mechanically connected to the locking means (9) and to the free end of which a mass element (22) is fastened.

2. The protection device as claimed in claim 1, characterized in that the device (6) which, in the event of a vehicle impact, moves the component of the vehicle seat, in particular the upper backrest part (5) of the backrest (2), is designed as a device which produces the torque (M) irrespective of whether the vehicle seat (1) is occupied.

3. The protection device as claimed in claim 2, characterized in that the torque-producing element (6) is formed by a force or energy accumulator, such as a prestressed spring element or a plurality of prestressed spring elements.

4. The protection device as claimed in either of claims 2 and 3, characterized in that the torque-producing device (6) is formed by a prestressed torsion spring (6a) which is preferably arranged in the pivoting axis (X-X).

5. The protection device as claimed in one of claims 1 to 4, characterized in that the blocking means (9) are formed from a lever system.

6. The protection device as claimed in claim 5, characterized in that the lever system of the locking means (9) for fixing (A) the component, in particular the upper backrest part (5), in the normal operational position is formed from at least two interacting levers (9a, 9b).

7. The protection device as claimed in claim 5 or 6, characterized in that the lever system is formed from a catch (9a) which is mounted pivotably in the upper backrest part (5), in particular in a transverse strut (5a) of the backrest part (5), and is supported, in a blocking position, on a counterbearing (4c) fixed relative to the upper backrest part (5) and from a pivotably mounted locking lever (9b) which engages in the catch (9a) in a blocking position and releases the catch (9a) in a release position.

8. The protection device as claimed in claim 7, characterized in that the pendulum-type lever (21) is connected in a rotationally fixed manner to the pivotably mounted locking lever (9a).

9. The protection device as claimed in claim 7 or 8, characterized in that the pendulum axis (Z-Z) of the pendulum-type lever (21) is aligned coaxially with the pivoting axis (Z-Z) of the pivotably mounted locking lever (9b).

10. The protection device as claimed in one of claims 7 to 9, characterized in that the mass element (22) at the free end of the pendulum-type lever (21) is arranged below the pivoting axis (Z-Z) of the pivotably mounted locking lever (9b).

11. The protection device as claimed in one or more of claims 1 to 10, characterized in that the mass element (22) at the free end of the pendulum-type lever (21) has a mass in the region of approximately 50 g to 300 g.

12. The protection device as claimed in one or more of claims 1 to 11, characterized in that the size of a mass of the mass element (22) at the free end of the pendulum-type lever (21) and a length (L) of the pendulum-type lever (21) between its pendulum axis (Z-Z) and a mass centre of gravity (MCG) at the free end are coordinated with each other in such a manner that, when accelerations (a) in the region of approximately 3 g to 20 g, in particular in the region of approximately 40 to 80 m/s², occur, the locking means (9) are brought by the pendulum-type lever (21) into an unblocked position.

13. The protection device as claimed in one of claims 1 to 12, characterized in that the pendulum-type lever (21) and the locking means (9), which are preferably formed from the lever system, is mounted in side walls of a pocket-like retaining part (60) arranged in the upper backrest part (5).

14. The protection device as claimed in one of claims 7 to 13, characterized in that the counterbearing (4c) is arranged at an upper end of a supporting part (4d), which is connected at the other end fixedly to the lower backrest part (4) and preferably protrudes into the pocket-like retaining part (60), and is formed by a stop surface for a lug (9d) of the catch (9a), said lug being arranged, for example, at a free lever end.

15. The protection device as claimed in one of claims 1 to 14, characterized by locking means (10) for fixing (K) the components, in particular the upper backrest part (5), against moving back from the safety position into the normal operational position.

16. The protection device as claimed in claim 15, characterized in that the locking means (10) for fixing (K) the upper backrest part (5) against moving back from the safety position into the normal operational position are designed as a rolling-body locking device which comprises a toothed ring (10d) which is arranged concentrically about the pivoting axis (X-X) of the upper backrest part (5) and is arranged within a cylindrical casing (10e), and rolling bodies (10g) which are arranged between the teeth (10f) of the toothed ring (10d) and between the toothed ring (10d) and casing (10e).

17. The protection device as claimed in one or more of claims 1 to 16, characterized in that a head restraint (8) is fastened in or on the upper backrest part (5) and, in a rear impact, is moved from a comfort position, in which its distance (A1) from the head of a seat user is approximately 40 to 110 mm, into an intercepting position, in which its distance (A2) from the head of a seat user is zero or virtually zero.

18. A mechanical system for detecting a vehicle impact, which has parts responding to acceleration, characterized in that a part responding to acceleration is formed from a pendulum, to the free end of which a mass element (22) is fastened.

19. The system as claimed in claim 18, characterized in that the pendulum is designed as a pendulum-type lever (21).

20. The system as claimed in claim 18 or 19, characterized in that the mass element (22) has a mass in the region of approximately 50 g to 300 g.

21. The system as claimed in one of claims 18 to 20, characterized in that the size of a mass of the mass element (22) and a length (L) of the pendulum are coordinated with each other in such a manner that, when accelerations in the region of approximately 3 g to 20 g, in particular in the region of approximately 40 to 80 m/s², occur, the pendulum is deflected by a defined amount.

22. The system as claimed in one of claims 19 to 21, characterized in that the pendulum-type lever (21) is connected in a rotationally fixed manner to a release lever, in particular to a pivotably mount locking lever (9b).

23. The system as claimed in claim 22, characterized in that the pendulum axis (Z-Z) of the pendulum-type lever (21) is aligned coaxially with the pivoting axis of the release lever.

24. The system as claimed in one of claims 18 to 23, characterized in that the pendulum axis (Z-Z) of the pendulum, in particular of the pendulum-type lever (21) and, if appropriate, the pivoting axis of the release lever is/are mounted in side walls of a pocket-like retaining part (6b).
